(19) United States
(12) Patent Application Publication
(10) Pub. No.: US 2005/0156452 A1
(43) Pub. Date: Jul. 21, 2005

(54) Child's car seat including means for tightening a safety belt strap

(75) Inventor: Richard Biaud, Trementines (FR)

Correspondence Address: David D. Brush;Westman, Champlin & Kelly, Suite 1600, 900 Second Avenue South, Minneapolis, MN, 55402-3319, US

(73) Assignee: Ampafrance, Cholet (FR)

(21) Appl. No.: 10/885,497

(22) Filed: Jul. 6, 2004

(30) Foreign Application Priority Data
Jul. 4, 2003 (FR) 03/08233

(51) Int. Cl. B60N 2/26

(52) U.S. Cl. 297/250.1

(57) ABSTRACT

This invention relates to a child's car seat designed to be fixed to a vehicle seat using at least one safety belt strap and comprising means of increasing the tension in the said strap, wherein it comprises at least one moving part with at least one support surface for the said strap and means of actuation acting on the said moving part so as to move the part between a released position and a tensioning position, in which the path of the said strap is lengthened and therefore its tension is increased, the relative positions of the said actuation means and the said moving part being such that the said actuation means are subjected to a force exerted by the said moving part that tends to oppose the said actuation means from returning to the said released position.

The domain of the invention is childcare. More precisely, the invention relates to child seats to be installed in a vehicle and held in place in the vehicle using a vehicle safety belt, and particularly the attachment of such seats in the vehicle.

Many types of car seats designed to be held in place using vehicle safety belts are already known.

Conventionally, child seats are fixed as follows:
the vehicle safety belt is pulled and the safety belt buckle is pushed in between the seat and its support structure (or base) and is pulled out again on the other side of the seat;
the safety belt buckle is fastened;
the strap is pulled to tighten it as much as possible, attempting to rewind it to take up all the slack in the strap;
a retaining tab provided on the seat support structure is folded over onto the strap to hold the strap firmly in place on the seat support structure.

These manipulations are often difficult. In particular, the installation phase consisting of attempting to tighten the belt is both difficult and tedious. But the safety belt strap must be tightened firmly in order to efficiently hold the seat in place in contact with the rear seat of the vehicle, particularly in case of a shock.

Not everyone is capable of tightening the strap sufficiently.

However if this strap is not tight, or is not tight enough, the child's seat can be projected forwards in case of shock until the strap becomes tight and conditions are such that the strap unwinder can detect a shock situation and block unwinding of the strap.

Moreover, the seat will move by a variable amount, in turns or when the brakes are applied suddenly, which reduces the child's comfort and safety.

Therefore, more or less important consequences can arise if the strap is not sufficiently tight.

Having said this, in practice it is observed that the phase consisting of tightening the strap is usually not done very well, and in some cases the strap can become loose so that the seat can tip forwards if the vehicle is involved in a collision.

Moreover, some users may not realise the usefulness and the importance of this operation to tighten the strap, and consequently they may not tighten it at all or not sufficiently.

One solution has been proposed in prior art to facilitate placement of the safety belt strap, consisting of providing a tightening element and an actuator to move the tightening element and means of locking the actuator in the active position.

According to this solution, the assembly of the tightening element and its actuator is such that in the active position, the force exerted by the tightening element (itself under the action of the force applied by the strap) tends to make the actuator move from its active position. This is why locking means have to be provided.

Therefore, this prior solution appears complex and not very reliable. It also involves a large number of mechanical parts which makes it long to assemble.

Furthermore, this device increases the number of manipulations necessary for the installation and removal of the seat, which is a constraint for the user.

Other equally complex and not very practical techniques have been put forward to define a particular path for the strap and means of modifying this path. This solution also assumes a large number of parts, and is not easy or ergonomic to use.

One particular purpose of the invention is to overcome the disadvantages of prior art.

More precisely, the purpose of the invention is to propose a child's car seat to be fixed in a vehicle using a safety belt strap and for which it is easy to apply a satisfactory and effective tension in the strap, particularly to assure safety of the child.

Another purpose of the invention is to provide such a seat that can be used easily, reliably with good control.

Another purpose of the invention is to provide such a child's seat that can be quickly and easily installed/removed by the user, without any complex manipulation, or guidance of the strap through particular elements defining a strap path.

Another purpose of the invention is to provide such a seat that is simple to design, easy to install and fit.

These objectives and others that will appear more clearly after reading the following description, are achieved according to the invention using a child's car seat designed to be fixed to a vehicle seat using at least one safety belt strap and comprising means of increasing the tension in the said strap, comprising at least one moving part with at least one support and/or guide surface for the said strap and means of actuation acting on the said moving part or on each of the said moving parts so as to move the part between a released position and a tensioning position, in which the path of the said strap is lengthened and therefore its tension is increased, the relative positions of the said actuation means and the said moving part being such that actuation means also form means of locking the said tensioning position, making use of a force exerted by the said strap on the said moving part to oppose the said actuation means from returning to the said released position.

The result is a very simple system, without it being necessary to provide specific guidance means on each side of the moving part(s), or means of locking these parts.

According to a first advantageous embodiment, the said actuation means include an element mounted free to pivot on the said seat.

Preferably, the said moving part is mounted free to pivot and has a sliding surface on which the said actuation means are free to displace.

In this case, the rotation axis of the said moving part is advantageously installed approximately at the mid-height of the said seat back.

The result is good force reduction and good efficiency of the system.

Advantageously, the said moving part and an element of the said actuation means form a cam and eccentric mechanism.

This approach is both simple and efficient.

Preferably, the said actuation means include remote control means.

The manipulations are then easy, and can reduce the forces to be applied.

According to one particular embodiment, the said control means include a pivoting lever. The said pivoting lever may particularly be connected to the said activation means through a linkage.

Advantageously, the said control means include a gripping element for reducing the force applied to the said moving part.

In this case, the said gripping handle may advantageously be at least partly concealed in the said seat and/or base in the tensioning position.

Preferably, the said support surface is bordered by two edges so as to form a passage for the said strap.

One advantageous embodiment includes two similar moving parts fitted on each side of the said seat.

According to a second embodiment of the invention, the said moving part is fitted on a carriage free to slide inside the said seat.

Advantageously, the said carriage slides approximately horizontally with respect to the bottom of the said seat, and has at least one extension that is approximately vertical and on which the said support surface(s) is (are) located.

The said support surfaces are preferably inclined from the said extension by about 45°.

Advantageously, the said sliding carriage is provided with two similar and simultaneously actuated support surfaces.

Preferably, the said carriage is actuated using a handle, through at least one connecting rod. For example, the said handle may extend in front of the said seat.

According to yet another advantageous embodiment, the said moving part defines a path for the said strap over at least one portion of the width of the said seat.

In this case, the said path advantageously defines a baffle moving towards the back of the said seat.

According to one particular embodiment of the invention, the car seat includes means of moving the said strap away from the back of the said seat.

This embodiment is advantageous particularly for a seat pivoting between:
a transport position facing the road; and
at least one child installation position, offset by about 90° from the said transport position.

This prevents the strap from disturbing rotation of the seat.

Advantageously, the said means for moving the said strap away are formed and/or installed on an approximately vertical part of a base of the said seat.

In particular, the said approximately vertical part of the base may define a window between two uprights. The said means for moving the said strap apart may include an approximately vertical extension for reception and/or guidance of the said strap.

According to one particular embodiment, the said means of moving the said strap apart include complementary moving strap tightening means.

Other characteristics and advantages of the invention will become clearer after reading the following description of two preferred embodiments of the invention, given for illustrative purposes and in no way limitative, and the appended drawings, wherein:

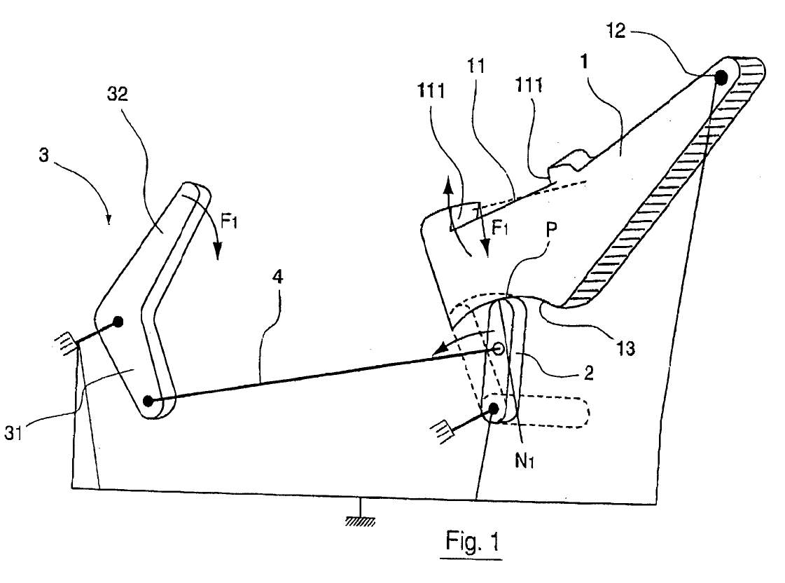

FIG. 1 diagrammatically illustrates a strap tightening device, designed to equip a child's seat according to the invention;

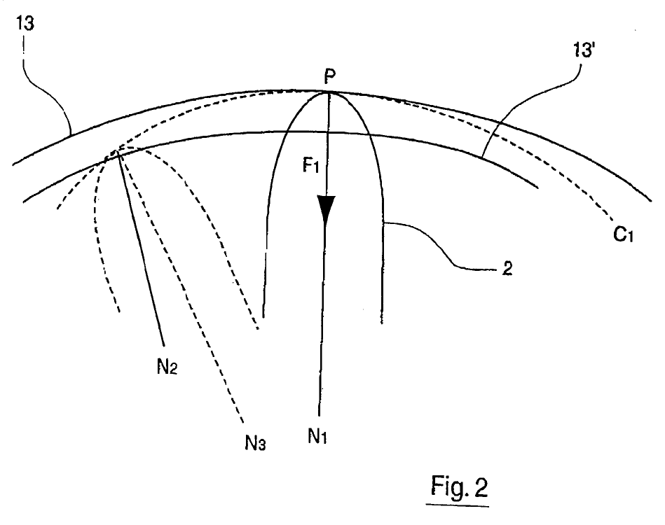

FIG. 2 illustrates the respective positions of the sliding surface of the moving part and the part of the actuation means in contact with this sliding surface;

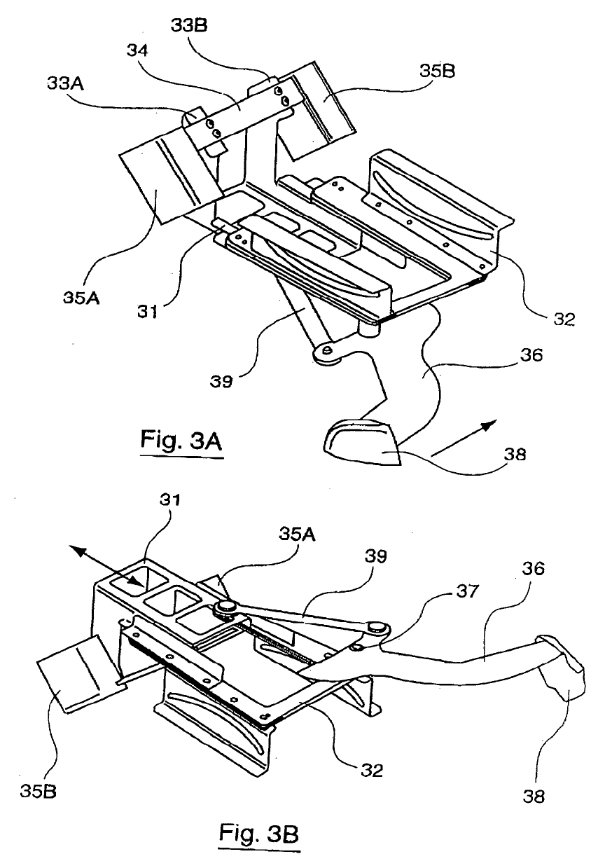

FIGS. 3A and 3B illustrate top and bottom views respectively of another embodiment of the invention, showing a sliding carriage in the released position;

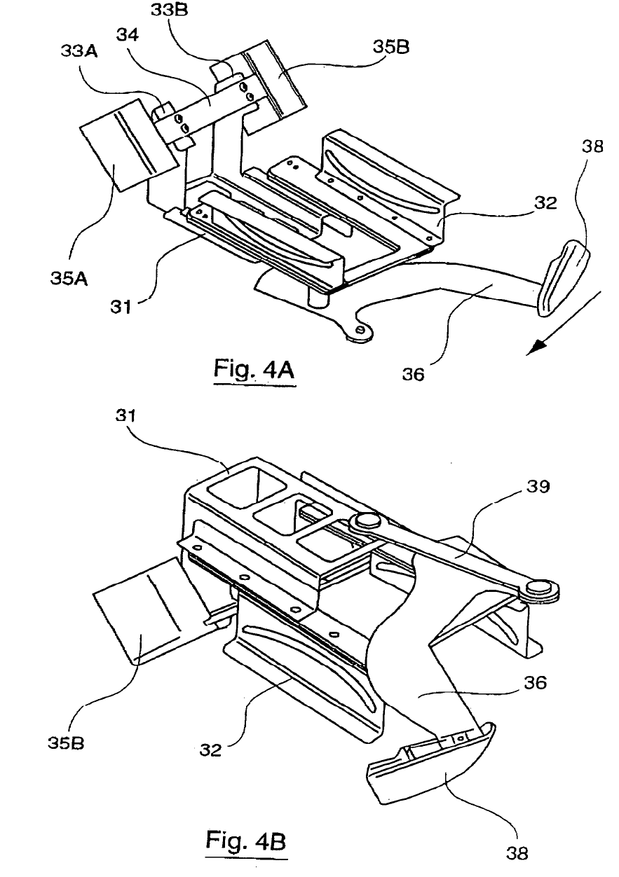

FIGS. 4A and 4B illustrate top and bottom views respectively of the system in FIGS. 3A and 3B, in the tensioning position;

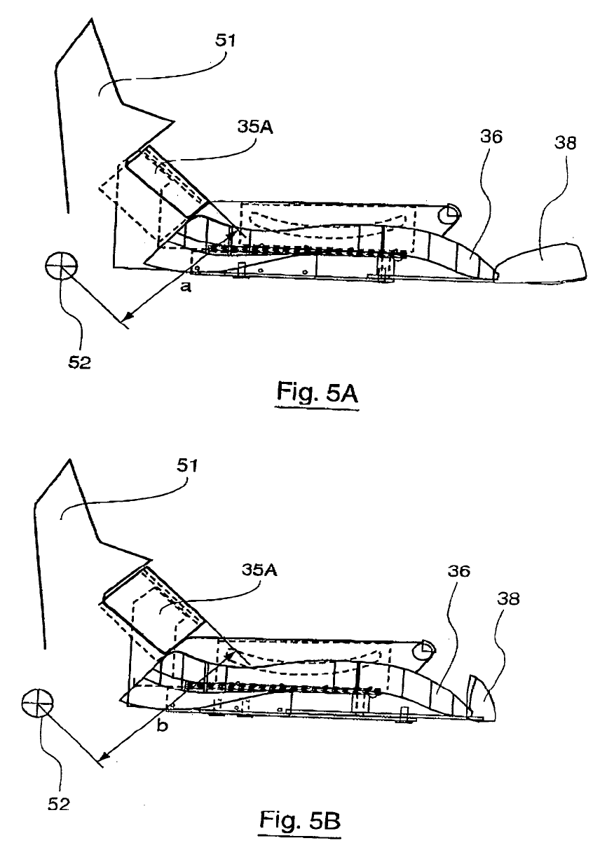

FIGS. 5A and 5B show sectional views of operation of the system of FIGS. 3A to 4B, in the released and tensioning positions respectively;

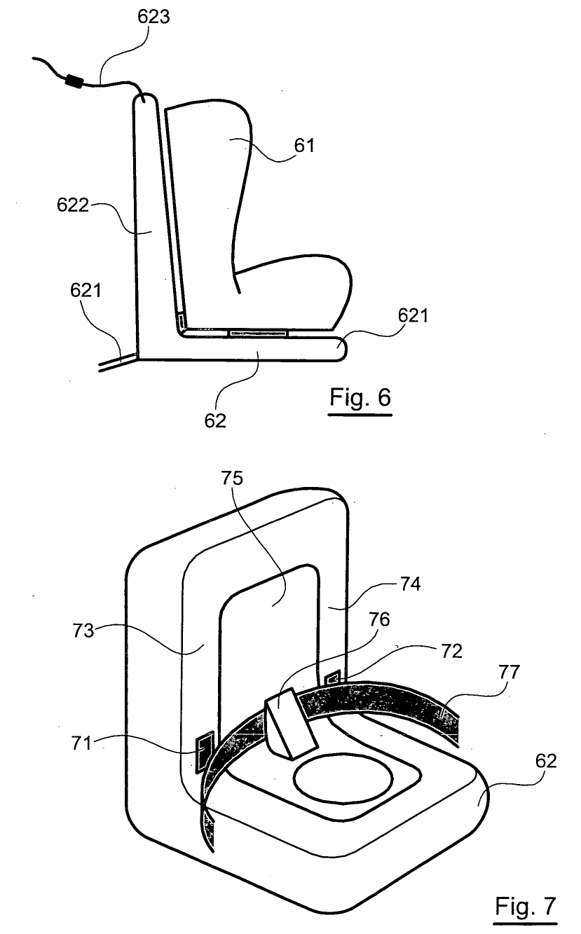

FIG. 6 illustrates another type of car seat, pivoting and installed on a base;

FIG. 7 presents the base of the car seat in FIG. 6.

As already mentioned, the principle of the invention is to provide an assembly of actuation means for actuating one (or more) moving part(s) for tightening the strap with which the actuation means and the moving part interact when they are in the active position, the actuation means supporting the moving part while the moving part holds the actuation means in the active position.

FIG. 1 shows a first embodiment of a child car seat according to the invention, that will be fitted to the seat of a vehicle using a strap of a safety belt, this seat comprising means of tightening the said strap or increasing its tension.

According to this embodiment of the invention, these means for tightening this belt strap include:
a moving part 1, or a cam, with a bearing surface 11 for the strap, this part 1 being installed free to rotate about a hinge pin 12 supported by a fixed part of the seat;
a connecting rod 2 forming a means of actuating the moving part, that can be moved between a released position and a strap tensioning position, this connecting rod being installed free to pivot about a hinge pin supported by a fixed part of the seat.

This type of moving part 1 may advantageously be provided on each side of the seat, or according to another possible embodiment it may be provided in a central position. Depending on the case, the two parts may be actuated or only one of the two parts may be actuated.

As shown in FIG. 1, the connecting rod 2 rotates the part 1 by sliding on a sliding surface 13 presented by the moving part 1.

The seat also includes control means 3 remote from the connecting rod 2 and connected to it through a linkage 4 such that the central means 3 are accessible starting from the front of the seat.

These control means 3 are actually composed of a V-shaped part installed free to pivot about a hinge pin supported by a fixed part of the seat, this part presenting:
a pivoting lever 31 connected to the connecting rod 2 through the linkage 4;
a handle 32 designed to be actuated from the front towards the back of the seat to tighten the strap.

According to the invention, assembly of the moving part 1 and the connecting rod 2 requires relative positioning such that the connecting rod is subjected to a force exerted by the moving part when it is in the tensioning position (illustrated in dashed lines), tending to prevent the connecting rod 2 from returning to its released position (illustrated in chain dotted lines).

The moving part 1 and the connecting rod 2 thus form a cam and eccentric mechanism. The hinge pin 12 of the moving part 1 is placed on the seat such that the connecting rod 2 moves through an intermediate position between the released position and the tensioning position, in which the force F1 applied by the strap is directed along the normal N1 to the sliding surface and passing through the point P (contact point between the connecting rod 2 and the part 1).

This intermediate position corresponds to the passage through a hard part due to the fact that in this position, the entire force F1 is transmitted to resist the action applied by the user on the pivoting lever 3.

This position is thus an unstable balance position in which the force F1 is aligned along the normal N1 to P, a situation in which the connecting rod 2 and the moving part 1 may tip either towards a tensioned position or a released position.

This is illustrated in FIG. 2, which shows the connecting rod 2 describing a circular trajectory C1, in contact with the sliding surface 13 of the moving part 1.

After passing through the intermediate position (in which the rod is shown in solid lines), the connecting rod 2 for example occupies a position like that illustrated in dashed lines. In this situation, the assembly is locked directly in the tensioning position, with no complementary locking means.

Moreover, as clearly shown in FIG. 1, the device is designed such that tightening is obtained by the following dynamic procedure: when the handle 32 is folded down as indicated by the arrow F1, the connecting rod 2 is moved by the lever 31 and the linkage 4 from a released position (shown in chained dotted lines in FIG. 1) to a tensioning position (in dashed lines in FIG. 1) which moves the moving part 1 upwards.

The result is thus a system that is easy to manipulate due to the reduced force, particularly due to the linkage and the position of the hinge pin of the moving part.

Furthermore, it is easy to check visually, since the lever(s) must be brought into the plane of the base. A specific colour (for example red) could also be marked on the moving part, or a message could be added, that can only be seen when the moving part is in the tensioning position.

Note that edges 111 could be provided to keep the strap in position laterally on the bearing surface 11, to prevent it from escaping from the bearing surface 11 while being tensioned.

According to another embodiment of the invention, the tightening system could include two bearing surfaces distributed on each side of the seat (or a bearing surface extending around all or a large part of the width of the seat) actuated simultaneously by the same control. An example embodiment of this approach is illustrated in FIGS. 3A to 5B.

According to this embodiment, a sliding carriage 31 could be provided free to slide with respect to a fixed part 32 attached to the seat, and more precisely to its seat bottom or its base.

FIGS. 3A to 4B show the following:
FIG. 3A: the system in the released position seen from above;
FIG. 3B: the system in the released position seen from below;
FIG. 4A: the system in the tensioning position seen from above
FIG. 4B: the system in the tensioning position seen from below.

Each of these figures will be referred to indifferently, depending on the requirements of the description.

The carriage 31 is provided with two extensions 33A and 33B approximately perpendicular to the carriage displacement. A support 34 is fitted on the free ends of these extensions, inclined at approximately 45°, that holds two blocks 35A and 35B at its ends (in other words approximately on each side of the seat) in which the straps will be fitted and that will pretension the straps. The carriage 31 is actuated by a handle 36 installed free to pivot about a rotation axis 37 attached to the fixed part 32.

This handle is terminated by a gripping element 38 accessible on the front of the seat, approximately under its seat bottom.

The handle is connected to the carriage 31 through a connecting rod 39.

The connecting rod 39 and the handle 36 are designed such that when the assembly is put into the tensioning position (see FIG. 4B), it is immobilised or locked without the use of any complementary elements.

As can be seen in FIGS. 5A and 5B that show sectional views of the system described above in the released position and in the tensioning position respectively, the movement of the handle 36 into the tensioning position causes the carriage 31 to slide towards the front of the seat, which also moves the tightening elements 35A and 35B towards each other. Therefore, these elements move upwards with respect to the seat back 51.

The result is an increase in the distance between the surface of these elements and a fixed attachment point of the strap 52 (B>A).

According to one variant, the two support elements 35A and 35B could be replaced by a single strap reception assembly that would tend to extend over a large part of the width of the seat, and possibly identifying a strap circulation path, for example forming a baffle.

Note also that a similar result can be obtained using other types of mechanism and dynamic system.

In all cases, the system obtained is particularly simple and efficient, not requiring any fixed strap guidance elements, and consequently significantly simplifying the assembly. Moreover, there is no need to provide specific locking in the tensioning position. This function is provided directly by means of controlling the movement from the released position to the tensioning position and vice versa.

According to another embodiment of the invention, particularly suitable for seats installed free to pivot on a base, fixed means are also provided for moving the strap away from the seat so that it does not oppose or disturb movement of the seat.

FIG. 6 diagrammatically illustrates such a pivoting seat. The seat 61 is installed on a base 62 so that it can pivot (63) from a transport position facing the road, to a child installation position offset by about 90°. In the embodiment illustrated, the base 62 is provided with an approximately horizontal support part 621 and an approximately vertical bearing part 622 in contact with the back of the vehicle seat.

The base may be fixed to the vehicle by two Isofix type clamps 641 and a complementary attachment 643 in the top part.

FIG. 7 illustrates the base on which strap tightening elements according to the invention are fitted.

Two moving cams 71, 72 are provided to hold and to tighten the strap, in the same way as for the embodiments described above. The actuation mechanism may be similar to that described above in relation to FIGS. 1 and 2.

Means are also provided for defining a strap path between the two moving cams. Elements defining this strap path may be fixed or mobile.

Thus, in one embodiment, the vertical part 622 includes two uprights 73, 74 defining a central window 75. An extension 76 extends upwards and inside this window 75, to guide the strap 77 and to release it from the area in which the seat moves.

This extension 76 has an adapted shape such that the strap fits into it and is held in place. The user guides the strap 77 inside the window 75, to move it along the extension 76.

According to one variant of the invention, this extension 76 may be mobile or it may be equipped with an additional moving cam to participate in the pre-tightening function. In this case, when the cams 71, 72 described above are activated to tighten the strap, the complementary cam moves in the opposite direction.

Advantageously, the three cams are fixed such that a single actuation device is sufficient to move these cams and tighten the strap.

1. Child's car seat designed to be fixed to a vehicle seat using at least one safety belt strap and comprising: at least one moving part with at least one support and/or guide: surface for the said strap; and
means of actuation acting on the said moving part or on each of the said moving parts so as to move the part between a released position and a tensioning position, in which the path of the said strap is lengthened and therefore its tension is increased,
the relative positions of the said actuation means and the said moving part being such that the actuation means also form means of locking the said tensioning position, making use of a force exerted by the said strap on the said moving part to oppose the said actuation means from returning in the said released position.

2-25. (canceled)

26. Child's car seat according to claim 1, wherein the said actuation means include an element mounted free to pivot on the said seat.

27. Child's car seat according to claim 1, wherein the said moving part is mounted free to pivot and has a sliding surface on which the said actuation means are free to displace.

28. Child's car seat according to claim 27, wherein the rotation axis of the said moving part is installed approximately at the mid-height of the said seat back.

29. Child's car seat according to claim 27, wherein the said moving part is an element of the said actuation means forming a cam and eccentric mechanism.

30. Child's car seat according to claim 1, wherein the said actuation means include remote control means.

31. Child's car seat according to claim 30, wherein the said control means include a pivoting lever.

32. Child's car seat according to claim 31, wherein the pivoting lever is connected to the said actuation means through a linkage.

33. Child's car seat according to claim 30, wherein the said control means include a gripping element for reducing the force applied to the said moving part.

34. Child's car seat according to claim 33, wherein the said gripping element is at least partly concealed in the said seat and/or a base of the seat in the tensioning position.

35. Child's car seat according to claim 1, wherein the said support surface is bordered by two edges so as to form a passage for the said strap.

36. Child's car seat according to claim 1, and further comprising two similar moving parts fitted on each side of the said seat.

37. Child's car seat according to claim 1, wherein the said moving part is fitted on a carriage free to slide inside the said seat.

38. Child's car seat according to claim 37, wherein the said carriage slides approximately horizontally with respect to a bottom of the said seat, and has at least one extension that is approximately vertical and on which the said support surface(s) is/are located.

39. Child's car seat according to claim 38, wherein the said support surface(s) is/are preferably inclined from the said extension by about 45°.

40. Child's car seat according to claim 38, wherein the said sliding carriage is provided with two similar and simultaneously actuated support surfaces.

41. Child's car seat according to claim 38, wherein the said carriage is actuated using a handle, through at least one connecting rod.

42. Child's car seat according to claim 41, wherein the said handle extends in front of the said seat.

43. Child's car seat according to claim 1, wherein the said moving part defines a path for the said strap over at least one portion of the width of the said seat.

44. Child's car seat according to claim 43, wherein the said path advantageously defines a baffle moving towards a back of the said seat.

45. Child's car seat according to claim 1, and further comprising means of moving the said strap away from a back of the said seat.

46. Child's car seat according to claim 45, wherein the said seat pivots between:
a transport position facing the road; and
at least one child installation position, offset from the said transport position by about 90°.

47. Child's car seat according to claim 45, wherein the said means for moving the said strap away are formed and/or installed on an approximately vertical part of a base of the said seat.

48. Child's car seat according to claim 47, wherein the said approximately vertical part of the base defines a window between two uprights, and the said means for moving the said strap apart include an approximately vertical extension for reception and/or guidance of the said strap.

49. Child's car seat according to claim 45, wherein the said means of moving the said strap apart include complementary moving strap tightening means.
